(19) United States
(12) Patent Application Publication
(10) Pub. No.: US 2016/0171037 A1
(43) Pub. Date: Jun. 16, 2016

(54) MODEL CHANGE BOUNDARY ON TIME SERIES DATA

(71) Applicant: GE Intelligent Platforms, Inc., Charlottesville, VA (US)

(72) Inventors: Sunil MATHUR, Foxboro, MA (US); Ward Linnscott BOWMAN, Foxboro, MA (US); Peter SAGE, Albany, NY (US); Justin DeSpenza MCHUGH, Niskayuna, NY (US); Richard A. CARPENTER, Charlottesville, VA (US)

(21) Appl. No.: 14/906,087

(22) PCT Filed: Jul. 19, 2013
(86) PCT No.: PCT/US2013/051199

§ 371 Date: Jan. 19, 2016

(51) Int. Cl. G06F 17/30

(52) U.S. Cl. CPC G06F 17/30368; G06F 17/30516; G06F 17/30551

(57) ABSTRACT

Provided is a method and system for detecting changes in models applied to analyze time series data. A method includes receiving at a processor a data stream transmitted from a sensor configured to measure an operating parameter of a component being monitored, wherein the data stream comprises at least time series data. The method also includes analyzing the data stream to identify a sequence of interest in the time series data, searching metadata stored separately for an appropriate model to apply to the time series data, and selecting the appropriate model. Information about the selected appropriate model is carried forward with the time series data.

### I. FIELD OF THE INVENTION

The present disclosure relates generally to time series models. More particularly, the present disclosure relates to detecting changes that have occurred over time and selecting an appropriate time series model to analyze specific time series data samples.

### II. BACKGROUND OF THE INVENTION

Time series data are sequences of time stamped records occurring in one or more usually continuous streams, representing some type of activity made up of discrete events. The time series data can be analyzed to make forecasts or predictions of future events based on previously observed values. The ability to index, search, and present relevant search results is important to understanding and working with complex systems emitting large quantities of time series data.

Examples of large systems may include, for example, locomotives, aircraft engines, automobiles, turbines, computers, appliances, spectroscopy systems, imaging devices, nuclear accelerators, biological cooling facilities, and power transmission systems. Such large and complex systems are generally monitored by a plurality of sensors to determine one or more performance characteristics of the system.

Time series forecasting is the use of a model to predict future values based on previously observed values. One common approach to time series forecasting is a data-driven approach that utilizes time series data to detect equipment behavior changes tracked via sensor measurements during operation of the system equipment.

Using the original raw time series data measured by the sensors, a model is created that explains and characterizes the occurrence of the observed values. Once a model is created, it can be used later to identify or recognize other sequences of observations. New data can be examined through the model to determine if the data fits a desired pattern to predict future events.

In order to effectively forecast future values in the new incoming time series data, the context describing the model being applied to the data should be known. However, this may be complicated in some situations, because the time series model may involve an iterative process where the model is continually updated.

During the query and/or analysis of the time series data, the models are often applied to the data to provide context to the values being manipulated. However, the models may be subjected to change over time, either through improvement of the model itself or through updates to represent changes in the situation or environment in which the time series data was generated. The accuracy and usefulness of the results of the analysis applied to such time series data is dependent on the model applied during the analysis.

An incorrectly or inappropriately applied model or a failure to understand a query/analysis, which encompasses a region where models should be changed, can lead to incorrect, distorted, or misunderstood results.

It may be desirable to provide a system and method that solves this issue by ensuring that the applied model is correct within the regions studied. Even when the model considered to be correct has changed within the region, the system and method of the present teaching detect such changes and apply the correct model.

The models created through the use of the raw data help to determine the relationships between components in the system. Being able to determine the model(s) used in the generation and processing of data is a practical concern if one desires to maintain a single, consistent view of the data both over time and as it moves between systems.

For example, in a query of time series data directed towards the operational parameters of an airplane engine, the analysis of the data will take into account that, over time, parts of the engine are likely to have been replaced due to routine maintenance. This maintenance work will change the operating characteristics of the engine. These changes will be reflected in the time series data generated by the engine's sensors.

In the absence of a mechanism to detect these changes in the model which is to be applied to the data (in this case, the specific configuration and ages of the parts in the engine), there is a possibility that the resulting data can be incorrectly processed. This is due to a lack of context surrounding the situation in which the data was collected.

It may also be desirable to provide a system and method that compensates for this limitation for the acquired time series data by detecting the model change and correctly applying the appropriate models, contextualizing the data.

Some conventional time series modeling techniques have addressed this problem by marking model changes explicitly through markups in the data and performing separate queries against each configuration. Another conventional option for solving this problem has been to simply ignore the potential discontinuity that may be introduced by picking a single model which is considered representative and running the query or performing the analysis. Other conventional attempts such as data warehouse and star schemas work poorly with time series data, as star schemas and the like tend to assume relatively stable configurations over long periods.

Thus, it may be desirable to provide a mechanism for the detection of changes in models when working with time series data. It may also be desirable to provide a system and method that reduces (or prevent) distortion in the results of manipulations performed on the data due to the application of these models. This invention allows the implementation of analytics and queries which are sensitive to such changes and can provide context in their output for otherwise unexpected changes in behavior as introduced by potential discontinuities at the model boundaries.

One can now use the context of which models were applied to regions of the data to explain changes in dependent data (such as outputs from previous calculations) that would otherwise appear to be errors, discontinuities or unexplained events. Consider the example of a car instrumented to record the miles per gallon over its lifetime by measuring the wheel speed and gas tank weight. If a user was to replace wheels with ones of a meaningfully different size, the gas mileage recorded will suddenly change. without a means of indicating that the vehicle physically changed at this point (the model in use has changed), one viewing only the recorded time-series data from the sensors would not be able to explain the sudden change.

It may also be desirable to system and method for detecting changes in time series forecasting models without requiring direct markups in the time series data to indicate the model applied and/or changes in the model. It may be desirable to provide a system and method that enables information about the models to move with the data itself, maintaining consistency as the data is exchanged between systems.

### III. SUMMARY OF THE EMBODIMENTS OF THE INVENTION

In at least one aspect, the present disclosure provides a method for detecting changes in models applied to analyze time series data. The method receiving at a processor a data stream transmitted from a sensor configured to measure an operating parameter of a component being monitored, wherein the data stream comprises at least time series data. The method also includes analyzing the data stream to identify a sequence of interest in the time series data, searching metadata stored separately for an appropriate time series model to apply to the time series data, and selecting the appropriate time series model. Information about the selected appropriate time series model is carried forward with the time series data.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### IV. BRIEF DESCRIPTION OF THE DRAWINGS

FIG. 1A illustrates an exemplary gas turbine engine for use with the system according to the present disclosure;

FIG. 1B illustrates a schematic diagram of the gas turbine engine of FIG. 1A and depicts an exemplary embodiment of a system including the gas turbine engine;

FIG. 2 illustrates a process flow diagram of a method for predicting events by associating time series data with various types of data in accordance with the present disclosure; and

FIG. 3 illustrates an exemplary computing system.

The present disclosure may take form in various components and arrangements of components, and in various process operations and arrangements of process operations. The present disclosure is illustrated in the accompanying drawings, throughout which, like reference numerals may indicate corresponding or similar parts in the various figures. The drawings are only for purposes of illustrating preferred embodiments and are not to be construed as limiting the disclosure. Given the following enabling description of the drawings, the novel aspects of the present disclosure should become evident to a person of ordinary skill in the art.

### V. DETAILED DESCRIPTION

The following detailed description is merely exemplary in nature and is not intended to limit the applications and uses disclosed herein. Further, there is no intention to be bound by any theory presented in the preceding background or summary or the following detailed description.

Throughout the application, description of various embodiments may use “comprising” language, however, it will be understood by one skill in the art, that in some specific instances, an embodiment can alternatively be descried using the language “consisting essentially of” or “consisting of.”

For purposes of better understanding the present teachings and in no way limiting the scope of the teachings, it will be clear to one skill in the art that the use of the singular includes the plural unless specifically stated otherwise. Therefore, the terms “a,” “an” and “at least one” are used interchangeably in this application.

In the context of the present teachings, the term “model” can be used to describe: (a) a description of physical or operational environment in which data was collected or generated, (b) the mathematics used to generate or transform data, or (c) a defined relationship defined over some, potentially infinite, duration. In general, it is the mapping of relationships between variables in the system which may include the calculation of or transformation into some collection of objects from some other collection.

Various embodiments of the system and method enable the detection of changes in models applied to analyze time series data. In various embodiments, the system and method detect the model changes when applied to the acquired time series data and correctly apply the appropriate models, contextualizing the data. Various embodiments reduce (or prevent) distortion in the results of manipulations performed on time series data due to the application of such changed models. Various embodiments allow the implementation of analytics and queries which are sensitive to such changes and can provide context in their output for otherwise unexpected changes in behavior as introduced by potential discontinuities at the model boundaries.

Various embodiments of the system and method detect changes in time series models without requiring direct markups in the time series data to indicate the model applied and/or changes in the model used to analyze the data. In various embodiments, the system and method enable information about the models to move with the data itself, maintaining consistency as the data is exchanged between systems.

Various embodiments of the system and method remove distortion in post-calculation usage of time series data. In various embodiments, the system and method solve provenance of data issues by tracking the changes in the model through all transformations. Thus, the system and method documents different changes that occur over the life of the model. Various embodiments provide a system and method for labeling and tracking different versions of the model as changes occur.

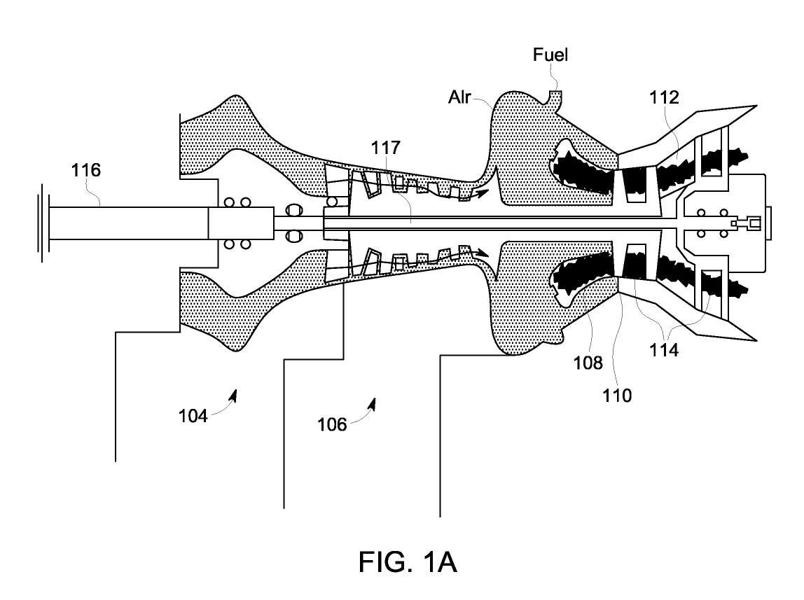

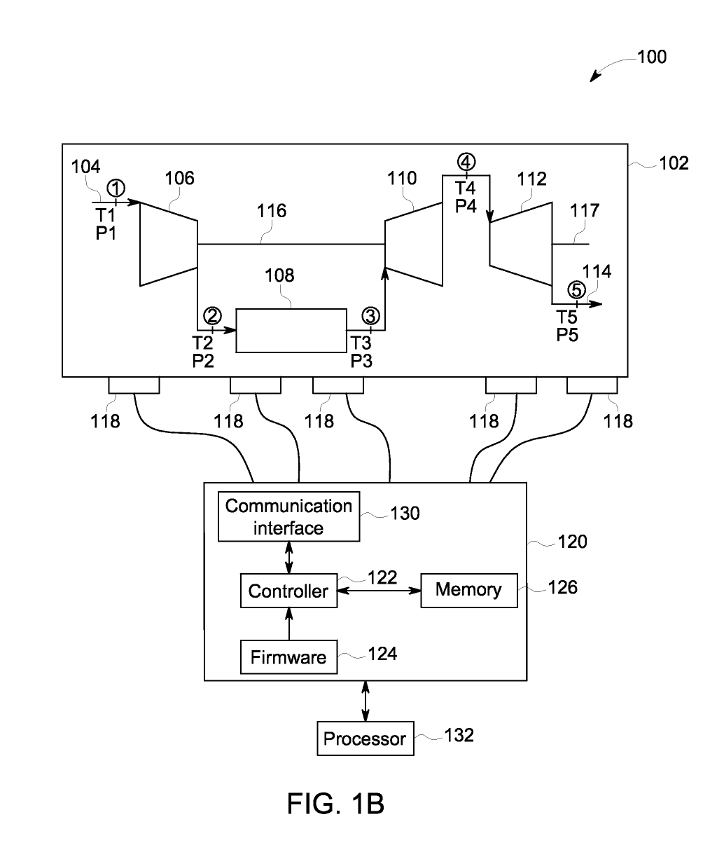

FIGS. 1A-1B illustrate an exemplary embodiment that relates to a system and method for detecting changes in time series models. In a particular embodiment, and as will be described in greater detail below, FIG. 1A illustrate a component, such as a gas turbine, being monitored by the system 100. It should be noted that the gas turbine engine component in the system describes an exemplary embodiment.

Those skilled in the art will appreciate that the disclosed system is not limited to a gas turbine engine in particular, and may be applied, in general, to a variety of systems or devices, such as, for example, locomotives, aircraft engines, automobiles, turbines, computers, appliances, spectroscopy systems, nuclear accelerators, medical equipment, biological cooling facilities, and power transmission systems, to name but a few.

FIGS. 1A-1B illustrate a system 100 that employs at least one model to analyze time series data for a gas turbine engine 102, which is used to power, for example, a helicopter (not shown). The system 100 also detects changes that occur within the model over time due to changes within operating parameters of the gas engine.

Gas turbine engine 102 comprises an air intake 104, a compressor 106, a combustion chamber 108, a gas generator turbine 110, a power turbine 112, and an exhaust 114. At the air intake 104, air is suctioned through the inlet section by the compressor 106. Air filtration occurs in the inlet section via particle separation. Air is then compressed by the compressor 106 where the air is used primarily for power production and cooling purposes.

Fuel and compressed air is burned in the combustion chamber 108 producing gas pressure, which is directed to the different turbine sections 110, 112. Gas pressure from the combustion chamber 108 is blown across the gas generator turbine rotors 110 to power the engine and blown across the power turbine rotors 112 to power the helicopter. The two turbines 110, 112 operate on independent output shafts 116, 117. Hot gases exit the engine exhaust 114 to produce a high velocity jet.

One or more sensors 118 are attached at predetermined locations 1, 2, 3, 4, and 5 to the gas turbine engine 102. Sensors 118 may be integrated into a housing of the gas turbine 102 or may be removably attached to the housing. Each sensor 118 can generate sensor data that is used by the prediction system 100, In general, a “sensor” is a device that measures a physical quantity and converts it into a signal which can be read by an observer or by an instrument. In general, sensors can be used to sense light, motion, temperature, magnetic fields, gravity, humidity, vibration, pressure, electrical fields, sound, and other physical aspects of an environment.

Non-limiting examples of sensors can include acoustic sensors, vibration sensors, vehicle sensors, chemical sensors/detectors, electric current sensors, electric potential sensors, magnetic sensors, radio frequency sensors, environmental sensors, fluid flow sensors, position, angle, displacement, distance, speed, acceleration sensors, optical, light, imaging sensors, pressure sensors and gauges, strain gauges, torque sensors, force sensors piezoelectric sensors, density sensors, level sensors, thermal, heat, temperature sensors, proximity/presence sensors, etc.

Sensors 118 provide sensor data to a monitoring device 120. The monitoring device 120 measures characteristics of the gas turbine engine 102, and quantifies these characteristics into data that can be analyzed by a processor 132. For example, the monitoring device may measure power, energy, volume per minute, volume, temperature, pressure, flow rate, or other characteristics of the gas turbine engine. The monitoring device may be a suitable monitoring device such as an intelligent electronic device (IED). As used herein, the monitoring device refers to any system element or apparatus with the ability to sample, collect, or measure one or more operational characteristics or parameters of the system.

The monitoring device 120 includes a controller 122, firmware 124, memory 126, and a communication interface 130. The firmware 124 includes machine instructions for directing the controller 122 to carry out operations required for the monitoring device. Memory 126 is used by the controller 122 to store electrical parameter data measured by the monitoring device 120.

Instructions from the processor 132 are received by the monitoring device 120 via the communications interface 130. In various embodiments, the instructions may include, for example, instructions that direct the controller 122 to mark the cycle count, to begin storing electrical parameter data, or to transmit to the processor 132 electrical parameter data stored in the memory 126. The monitoring device 120 is communicatively coupled to the processor 132. One or more sensors 118 may also be communicatively coupled to the processor 132.

The system 100 gathers data from the monitoring device 120 and other sensors 118 for detecting changes in time series models. The system outputs data and runs a process algorithm according to aspects disclosed herein. The process algorithm includes instructions for detecting changes in models used to analyze time series data.

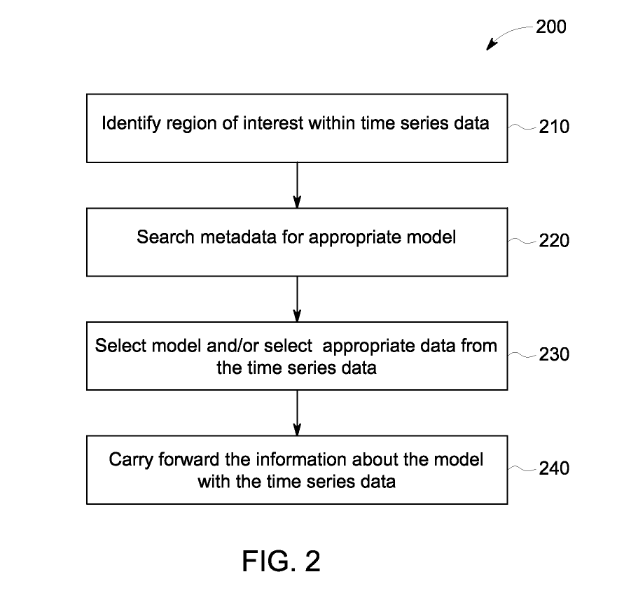

In FIG. 2, discussed more fully below, the system determines the model(s) used to generate and process time series data to maintain a single, consistent view of the data both over time and as the data moves between systems. The system detects changes in the model which should be applied to time series data samples within a region of interest. The detected changes occur without the need to individually markup samples or preemptively divide samples into regions based on models that can appropriately be applied.

The system identifies the correct model(s) to apply to a region of interest based on metadata stored separately from either the model or the time series data. For example, inception date, retirement date, etc., represent types of data that will be included in the metadata to identify model changes. Other types of metadata include means for indicating which streams or objects to which the model is applicable, as well as a means to determine whether the model relates to a higher level logical object through which it may be referenced.

Consider the example of a machine name that refers to a given collection of parts over a given period of time, were some subset of those parts may be swapped out into other machines at interval. In another example, gas turbine repairs can work in this manner. For example, a particular part is in a first machine for a period of time and then used as an operational spare during the repair of a second machine. The returned data from this part must be contextualized over the time periods to make sense. Still further types of data can include a means for finding/referencing the related model itself.

In the exemplary embodiment of FIG. 1B, a process algorithm receives a stream of data transmitted from the sensors 118 and monitoring device 120. For example, temperature and pressure sensors 118, collectively indicated generally by reference numeral 118, are located on the gas turbine engine 102. Of course, there may be any number of sensors located throughout the gas turbine engine 102 for monitoring any number of conditions.

The various sensors 118 throughout the system may provide operational data regarding the gas turbine engine 102 to the monitoring device 120. Moreover, the controller 122 may also provide data to the monitoring device 120. By way of example, the monitoring device 120 may receive and process data regarding the temperature within the engine, the pressure within the engine, the heat rate, exhaust flow, exhaust temperature, and pressure rate or a host of any other operating conditions regarding the engine 102.

The operational data will also include any data that reflects any changes in the time series model. These models may be subject to change over time either through improvements in the model. Changes may also occur through updates in the situation or environment in which the time series data was generated. For example, data related to maintenance performed on any component within the engine will constitute a change in the characteristics of the engine's performance. This change will be reflected in the time series data generated by the engine's sensors.

FIG. 2 illustrates a process flow diagram of a method 200 for predicting events by associating time series data with various types of data in accordance with the present disclosure.

In block 210, the process algorithm analyzes the incoming data stream to identify a region of interest within the time series data based on the time series query. For example, the process algorithms may perform pattern matching to known template patterns to identify the sequences of interest. The pattern matching technique may employ at least one of statistics, regression, neural networks, decision trees, Bayesian classifiers, Support Vector Machines, clusters, rule induction, nearest neighbor, and cross-correlation and pyramidal matching. Pattern matching, or a simple lookup table, can be used to determine the currently applied model. In the event of models with a bounded temporal usefulness.

Once a sequence is identified that matches a known template pattern, in block 220, the process algorithm searches the metadata for the appropriate models to apply over the temporal region of interest.

In block 230, based on the metadata, the appropriate model is selected. Alternatively or in conjunction with, the appropriate data from the time series data can also be selected as dictated by the selected model.

In block 240, information about the appropriate model(s) to apply to the time series data is then carried forward with the time series data and used, as needed, in further queries and/or analytics applications. This process thus combines both relational and time series data in the accomplishment of the query and analytics. The present teachings may be applied to either asset models or mathematical models used to describe relationships between time series samples.

In general, the embodiments remove distortion in post-calculation usage of data. This distortion removal effect is shown when, later reusing the data or making comparisons between data collected at different points which had gone through the process illustrated in FIG. 2 and had different models apply but are, facially the “same” type of data. At this point, for example, differences in the outcomes of processing each group of data can then be explained. In the absence of the embodiments, there is no direct or conveniently traceable method to explain the difference in the initial results or subsequent generations of results based on those initial results.

The accuracy and usefulness of the results of analysis applied to such time series data is dependent on the model applied during said analysis. An incorrectly or inappropriately applied model or failure to understand a query/analysis encompasses a region where models should change can lead to incorrect, distorted, or misunderstood results. This system and method of the present teaching solves this issue by ensuring the applied model is correct within the regions studied, even in the event the model considered to be correct changes within the region.

The system and method solves provenance of data issues by documenting the chronology of the changes in the model. If one considers that each calculated or observed result “carries forward” information about the models applied in its creation/processing/contextualizing, one forms a provenance for the data. Thus, the data context provided in the models will move with the data itself. Being carried forward at each step, the context is permanent and can be used to resolve the history and assumed accuracy of the data in the future.

The application of the model context over intervals removes the need for data warehouse-like schemas which have to be maintained and synchronized between various systems. Using this invention, the movement of context with the data means the provenance can be determined at time of use without having to search external systems.

The embodiments further provide a mechanism for identifying and tagging different versions of the model as the changes occur. This provision may be a prerequisite for actions shown in FIG. 2. For example, blocks 220 and 230 implicitly convey that this must have occurred in order to support the operations.

The system provides a mechanism for explicitly labeling different versions of the models that are to be applied to data in the system and determining the models region of application in the data for each version. This process of identifying the different versions can be used to track the movement and history of the components or the progression of modeling relationships in the system.

This system and method for detecting changes in time series models offers several technical and commercial advantages. One of the technical advantages is that the information about the model changes is embedded into the system itself, which removes the need for external handling or processing to address the changes in the model.

Another technical advantage is that query results are more consistent with the observed behavior relative to changes in the field over time. A further technical advantage is that the system provides fault tolerance against spurious correlations, errors and inconsistent output data due to model alteration over region of interest.

A common use case is the reprocessing of historical data within a system. For example, in the event a user does not accurately track the model applied to the data originally, the re-done calculations can differ from the original outcomes as the models used may differ. This becomes problematic when working with a multistep process. In this case, one may end up with intermediate results which are inconsistent with the original calculations and lead to a different outcome.

Alternatively, another potential is that one introduces older calculated and stored results (which may themselves have been treated as time series data by the system) leading to a situation where the expected results and the final results differ because some set of the inputs changed based on inconsistently applied models.

One of the commercial advantages is that the system and method reduce post-processing of analytic output data prior to use of the data. Another commercial advantage is the traceability of changes that occur in the models over time provides more rapid explanations of unexpected or inconsistent results of analytics and queries. This is beneficial for compliance tracking and implementation. A further commercial advantage is the ability to query on model use boundaries directly, introducing an additional dimension of introspection.

Being able to track the applied models can enable an organization to observe the changes wrought by a model change without having to guess at the time of the change or have to compare various systems of record to determine where the change became relevant. By way of example, consider a system that monitors a vehicle throughout its lifetime. An analyst may wonder how a replacement of the air intake impacted delivered horsepower.

Traditionally, the maintenance records would have to be compared to the time series data to determine where in the stream the new intake became a meaningful contributor. Assuming the vehicle's physical configuration is modeled in the system, the system would allow the analyst to use the intake replacement as a change in the model itself and query for data on either side of that model change. This ability allows a direct and convenient comparison of the data before and after.

Each model is constructed based on its own set of original raw time series data, which defines the region and the boundary of the model. It will be apparent to those skilled in the art that these are exemplary advantages and that additional advantages may be provided by the system and method.

For certain fields or applications, it may be advantageous to add markups indicating the appropriate model to apply directly to the time series data. During such queries, this markup can be used to explicitly segment the data by applicable models. The correct model can then be applied to sub-regions of the region of interest during the analysis or a query based on the initial results.

In some applications, a manual search can be conducted through the region of interest, wherein the regions are separated into appropriate sub-regions, and the appropriate models are applied to each sub-region. In other applications the time series data can be partitioned initially based on the model to be applied at the time of collecting the time series data. The resultant partitions provide a means of preventing an analytic or query from encompassing multiple models within a selected region without the explicit decision to do so.

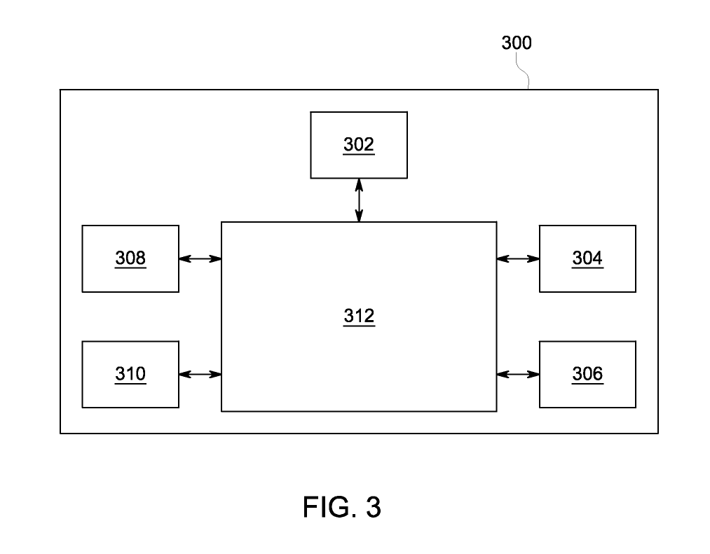

Elements of the system 100 described above may be implemented on any general-purpose computer 300 with sufficient processing power, memory resources, and network throughput capability to handle the necessary workload demand. FIG. 3 illustrates a typical, computer system suitable for implementing one or more embodiments disclosed herein.

The general-purpose computer 300 includes a processor 312 (which may be referred to as a central processor unit or CPU) that is in communication with memory devices including secondary storage 302, read only memory (ROM) 304, random access memory (RAM) 306, input/output (I/O) 308 devices, and network connectivity devices 310. The processor may be implemented as one or more CPU chips.

It is noted that components (simulated or real) associated with the system 100 can include various computer or network components such as servers, clients, controllers, industrial controllers, programmable logic controllers (PLCs), communications modules, mobile computers, wireless components, control components and so forth that are capable of interacting across a network.

Similarly, the term controller or PLC as used herein can include functionality that can be shared across multiple components, systems, or networks. For example, one or more controllers can communicate and cooperate with various network devices across the network. This can include substantially any type of control, communications module, computer, I/O device, sensors, Human Machine Interface (HMI) that communicate via the network that includes control, automation, or public networks. The controller can also communicate to and control various other devices such as Input/Output modules including Analog, Digital, Programmed/Intelligent I/O modules, other programmable controllers, communications modules, sensors, output devices, and the like.

The network can include public networks such as the Internet, Intranets, and automation networks such as Control and Information Protocol (CIP) networks including DeviceNet and ControlNet. Other networks include Ethernet, DH/DH+, Remote I/O, Fieldbus, Modbus, Profibus, wireless networks, serial protocols, and so forth.

The secondary storage 302 is typically comprised of one or more disk drives or tape drives and is used for non-volatile storage of data and as an over-flow data storage device if RAM 306 is not large enough to hold all working data. Secondary storage 302 may be used to store programs that are loaded into RAM 306 when such programs are selected for execution. The ROM 304 is used to store instructions and perhaps data that are read during program execution. ROM 304 is a non-volatile memory device that typically has a small memory capacity relative to the larger memory capacity of secondary storage. The RAM 306 is used to store volatile data and perhaps to store instructions. Access to both ROM 304 and RAM 306 is typically faster than to secondary storage 302.

I/O 308 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 310 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices.

These network connectivity devices 310 may enable the processor 312 to communicate with an Internet or one or more intranets. With such a network connection, it is contemplated that the processor 312 might receive information from the network, or might output information to the network in the course of performing the above-described method steps. Such information, which is often represented as a sequence of instructions to be executed using processor 312, may be received from and outputted to the network.

The processor 312 executes instructions, codes, computer programs, scripts that it accesses from hard disk, floppy disk, optical disk (these various disk based systems may all be considered secondary storage 302), ROM 304, RAM 306, or the network connectivity devices 310.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

Alternative embodiments, examples, and modifications which would still be encompassed by the disclosure may be made by those skilled in the art, particularly in light of the foregoing teachings. Further, it should be understood that the terminology used to describe the disclosure is intended to be in the nature of words of description rather than of limitation.

Those skilled in the art will also appreciate that various adaptations and modifications of the preferred and alternative embodiments described above can be configured without departing from the scope and spirit of the disclosure. Therefore, it is to be understood that, within the scope of the appended claims, the disclosure may be practiced other than as specifically described herein.

We claim:

1. A method for detecting changes in models applied to analyze time series data, the method comprising:
receiving at a processor a data stream transmitted from a sensor configured to measure an operating parameter of a component being monitored, wherein the data stream comprises at least time series data;
analyzing the data stream to identify a sequence of interest in the time series data;
searching stored metadata for an appropriate model to apply to the time series data; and
selecting the appropriate model.

2. The method for detecting changes according to claim 1, wherein the metadata includes at least one from the group including inception date, retirement date, applicable objects, and higher-level relations.

3. The method for detecting changes according to claim 1, wherein the metadata is stored separately.

4. The method for detecting changes according to claim 1, further comprising carrying forward information about the selected appropriate model with the time series data.

5. The method for detecting changes according to claim 4, wherein the carrying forward produces carry forward model data.

6. The method for detecting changes according to claim 5, further comprising carrying forward information about the selected appropriate model with the time series data.

7. The method for detecting changes according to claim 6, wherein the carrying forward produces carry forward model data.

8. A tangible computer readable media storing instructions, when said instructions, when executed are adapted to execute a process within a computer system with a method detecting changes in models applied to analyze time series data, the method comprising:
receiving at a processor a data stream transmitted from a sensor configured to measure an operating parameter of a component being monitored, wherein the data stream comprises at least time series data;
analyzing the data stream to identify a sequence of interest in the time series data;
searching stored metadata for an appropriate model to apply to the time series data; and
selecting the appropriate model.

9. The tangible computer readable media according to claim 8, wherein the metadata includes at least one from the group including inception date, retirement date, applicable objects, and higher-level relations.

10. The tangible computer readable media according to claim 8, wherein the metadata is stored separately.

11. The tangible computer readable media according to claim 8, further comprising carrying forward information about the selected appropriate model with the time series data.

12. The tangible computer readable media according to claim 11, wherein the carrying forward produces carry forward model data.

13. The tangible computer readable media according to claim 12, further comprising carrying forward information about the selected appropriate model with the time series data.

14. The tangible computer readable media according to claim 13, wherein the carrying forward produces carry forward model data.

15. A cache system comprising:
at least one processing unit and at least one database;
a plurality of sensors in communication with the at least one processing unit;
wherein the at least one processing unit is configured to:
receive at a processor a data stream transmitted from a sensor configured to measure an operating parameter of a component being monitored, wherein the data stream comprises at least time series data;
analyze the data stream to identify a sequence of interest in the time series data;
search stored metadata for an appropriate model to apply to the time series data; and
select the appropriate model.

16. The cache system according to claim 15, wherein the metadata includes at least one from the group including inception date, retirement date, applicable objects, and higher-level relations.

17. The cache system according to claim 15, wherein the metadata is stored separately.

18. The cache system according to claim 15, further comprising carrying forward information about the selected appropriate model with the time series data.

19. The cache system according to claim 18, wherein the carrying forward produces carry forward model data.

20. The cache system according to claim 19, further comprising carrying forward information about the selected appropriate model with the time series data.
